(19) United States
(12) Patent Application Publication
(10) Pub. No.: US 2026/0202868 A1
(43) Pub. Date: Jul. 16, 2026

(54) Power Supply Device, Heat Regulation Method and Power Supply System

(71) Applicant: PowerX Semiconductor Corporation, Hsinchu County (TW)

(72) Inventors: Tsung-Wei Huang, Hsinchu County (TW); Ding-Yu Wei, Hsinchu County (TW); Yueh-Lung Kuo, Hsinchu County (TW)

(73) Assignee: PowerX Semiconductor Corporation, Hsinchu County (TW)

(21) Appl. No.: 19/086,096

(22) Filed: Mar. 20, 2025

(30) Foreign Application Priority Data
Jan. 16, 2025 (TW) 114101725

(51) Int. Cl. G05F 1/567; G05F 1/573; H02J 1/10

(52) U.S. Cl. CPC G05F 1/567; G05F 1/573; H02J 1/10

(57) ABSTRACT

A power supply device includes a power switch, configured to convert a first power signal into a second power signal according to a control signal; a first current source, configured to provide a current signal to a first node; a control circuit, configured to convert the current signal into the control signal; and a temperature-controlled current sink circuit, including at least one temperature sensing element, disposed at at least one location on the power switch, configured to generate at least one voltage signal, wherein the at least one voltage signal is respectively related to a temperature of the at least one location; an error amplifier, configured to generate a regulation signal according to the at least one voltage signal and a reference voltage; and a regulation switch, configured to sink a regulation current from the current signal at the first node according to the regulation signal.

### BACKGROUND OF THE INVENTION

### 1. Field of the Invention

The present invention relates to a power supply device, a heat regulation method and a power supply system, and more particularly, to a power supply device, a heat regulation method and a power supply system capable of actively monitoring and regulating current of a power switch.

### 2. Description of the Prior Art

In modern electronic systems, high-side power switches are widely used in power management. To enhance system reliability and power handling capability, conventional techniques typically employ multiple high-side power switches connected in parallel for power supply. However, this configuration presents several challenges in practical applications. For example, due to process variations, the on-resistance of power switches may vary by ±20%. This variation can cause current to tend to flow concentratedly through power switches with lower on-resistance during system startup, and potentially subject the power switches to excessive power loads. This leads to rapid temperature increases and may ultimately trigger thermal shutdown protection mechanisms, thus preventing successful system startup.

To address this issue, conventional solutions typically employ current balance or current sharing techniques. These techniques attempt to distribute current evenly among multiple parallel power switches. However, in situations with high system power requirements, even with current balancing techniques implemented, the temperature of certain power switches may still rapidly rise to thermal shutdown levels (e.g., 150° C.) during the startup process.

Another problem with existing technology is that most solutions primarily focus on current distribution without directly addressing temperature control, making them ineffective at preventing thermal shutdown issues caused by localized hot spots or transient high currents. Moreover, traditional protection methods typically completely cut off power switches when approaching thermal shutdown temperature, potentially interrupting system power supply. This “all-or-nothing” protection strategy affects system stability and reliability.

Therefore, the industry urgently seeks a more effective method that can both prevent power switch overheating while ensuring stable system operation.

### SUMMARY OF THE INVENTION

Therefore, the present invention is to provide a power supply device, a heat regulation method and a power supply system for preventing the power switch overheating while ensuring stable system operation.

An embodiment of the present invention discloses a power supply device, which comprises a power switch, configured to convert a first power signal into a second power signal according to a control signal; a first current source, configured to provide a current signal to a first node; a control circuit, electrically connected to the power switch and further to the first current source at the first node, configured to convert the current signal into the control signal; and a temperature-controlled current sink circuit, comprising at least one temperature sensing element, disposed at at least one location on the power switch, configured to generate at least one voltage signal, wherein the at least one voltage signal is respectively related to a temperature of the at least one location; an error amplifier, electrically connected to the at least one temperature sensing element for receiving the at least one voltage signal, configured to generate a regulation signal according to the at least one voltage signal and a reference voltage; and a regulation switch, electrically connected to the first node and the error amplifier, configured to sink a regulation current from the current signal at the first node according to the regulation signal.

Another embodiment of the present invention discloses a heat regulation method, utilized in a power supply device comprising a power switch and a control circuit. The heat regulation method comprises providing a current signal; converting the current signal into a control signal, to control the power switch to output a power signal; sensing a temperature at at least one location on the power switch, to generate at least one voltage signal; generating a regulation signal according to a difference between a reference voltage and the at least one voltage signal; and extracting a regulation current from the current signal according to the regulation signal.

Another embodiment of the present invention discloses a power supply system, comprising a plurality of power supply devices. Each of the power supply devices comprises a power switch, configured to convert a first power signal into a second power signal according to a control signal; a first current source, configured to provide a current signal to a first node; a control circuit, electrically connected to the power switch and the first current source at the first node, configured to convert the current signal into the control signal; and a temperature-controlled current sink circuit, comprising at least one temperature sensing element, disposed at at least one location on the power switch, configured to generate at least one voltage signal, wherein the at least one voltage signal is respectively related to a temperature of the at least one location; an error amplifier, electrically connected to the at least one temperature sensing element for receiving the at least one voltage signal, configured to generate a regulation signal according to the at least one voltage signal and a reference voltage; and a regulation switch, electrically connected to the first node and the error amplifier, configured to sink a regulation current from the current signal at the first node according to the regulation signal; wherein power switches of the plurality of power supply devices are connected in parallel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a power supply device according to an embodiment of the present invention.

FIG. 2A illustrates a schematic diagram of a power supply device according to an embodiment of the present invention.

FIG. 2B illustrates a schematic diagram of a relationship between voltage signals and temperature.

FIG. 3A illustrates a schematic diagram of temperature regulation of the power supply device shown in FIG. 2A.

FIG. 3B illustrates a schematic diagram of a relationship between output current and temperature of the power switch shown in FIG. 2A.

FIG. 4A illustrates a schematic diagram of temperature regulation of the power supply device shown in FIG. 2A.

FIG. 4B illustrates a schematic diagram of a relationship between output current and temperature of the power switch shown in FIG. 2A.

FIG. 5 illustrates a schematic diagram of a power supply device according to an embodiment of the present invention.

FIG. 6A illustrates a schematic diagram of a power supply device according to an embodiment of the present invention.

FIG. 6B illustrates a schematic diagram of temperature regulation of the power supply device shown in FIG. 6A.

FIG. 6C illustrates a schematic diagram of a relationship between output current and temperature of the power switch shown in FIG. 6A.

FIG. 7 illustrates a schematic diagram of a heat regulation process according to an embodiment of the present invention.

FIG. 8 illustrates a schematic diagram of a power supply system according to an embodiment of the present invention.

### DETAILED DESCRIPTION

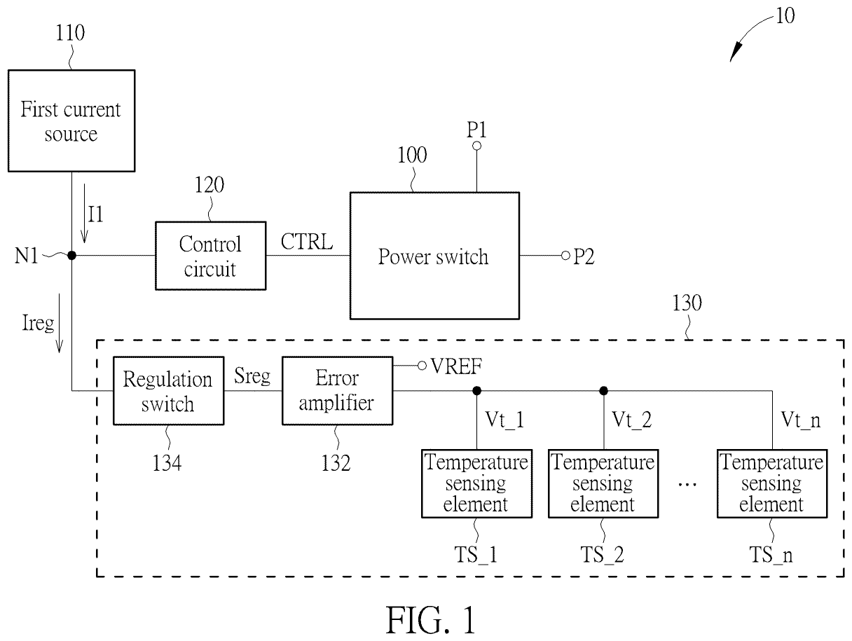

Please refer to FIG. 1, which shows a functional block diagram of a power supply device 10 according to an embodiment of the present invention. The power supply device 10 includes a power switch 100, a first current source 110, a control circuit 120, and a temperature-controlled current sink circuit 130, which actively monitors the temperature of the power switch 100 and provides timely regulation when temperature rises too high, which prevents unnecessary triggering of thermal shutdown protection mechanisms while maintaining stable system operation. Specifically, the power switch 100 may be a high-side power switch, used to convert a first power signal P1 into a second power signal P2 according to a control signal CTRL generated by the control circuit 120. The first current source 110 is electrically connected to the control circuit 120 and the temperature-controlled current sink circuit 130 to form a first node N1, and the first current source 110 provides a current signal I1 to the first node N1. The control circuit 120 is electrically connected between the power switch 100 and the first node N1, and configured to receive the current signal I1 from the first current source 110 and convert it into the control signal CTRL to drive the power switch 100. The temperature-controlled current sink circuit 130 may sense the temperature of the power switch 100 and accordingly sink (or extract) a regulation current Ireg from the first node N1 or control the magnitude of the regulation current Ireg, thereby adjusting the magnitude of the current signal I1 flowing into the control circuit 120 and subsequently adjusting the control signal CTRL generated by the control circuit 120. As a result, the second power signal P2 output by the power switch 100 is temperature-regulated, which prevents the power switch 100 from overheating while ensuring stable system operation.

Specifically, as shown in FIG. 1, the temperature-controlled current sink circuit 130 includes temperature sensing elements TS_1 to TS_n, an error amplifier 132, and a regulation switch 134. The temperature sensing elements TS_1 to TS_n are disposed at at least one location (or detection point) on the power switch 100, used to sense the temperatures at the at least one disposed location and generate corresponding voltage signals Vt_1 to Vt_n. The error amplifier 132 is electrically connected to the temperature sensing elements TS_1 to TS_n to receive the voltage signals Vt_1 to Vt_n, and generate a regulation signal Sreg based on the voltage signals Vt_1 to Vt_n and a reference voltage VREF. The regulation switch 134 is electrically connected between the first node N1 and the error amplifier 132, used to sink (or extract) the regulation current Ireg from the current signal I1 at the first node N1 according to the regulation signal Sreg. In other words, when the temperature at one or more detection points of the power switch 100 becomes too high, one or more of the voltage signals Vt_1 to Vt_n will cause the error amplifier 132 to correspondingly change its output regulation signal Sreg, thereby driving the regulation switch 134 to sink more regulation current Ireg, subsequently adjusting the control signal CTRL and reducing the conductivity of the power switch 100, which achieves temperature control.

It should be noted that while FIG. 1 shows the plurality of temperature sensing elements TS_1 to TS_n, in practice, the number n of temperature sensing elements TS_1 to TS_n may be greater than or equal to 1, meaning that the temperature-controlled current sink circuit 130 needs to include at least one temperature sensing element to achieve the function of temperature detection and timely current sinking. Moreover, although FIG. 1 shows the temperature sensing elements TS_1 to TS_n separately from the power switch 100, this is only for ease of explanation. In practice, the temperature sensing elements TS_1 to TS_n are disposed on the power switch 100, such as at one or more temperature hot spots on the power switch 100, but not limited to these locations, to monitor temperature changes in real-time.

Through the above architecture, the power supply device 10 of the embodiment of the present invention can actively monitor and control the temperature of the power switch 100 and provide timely regulation when temperature rises too high, which prevents the triggering of thermal shutdown protection mechanisms while maintaining stable system operation. This temperature control method differs from conventional all-or-nothing protection methods and can more effectively balance system performance and reliability requirements.

It should be noted that FIG. 1 explains the main architecture for implementing the temperature regulation mechanism of the present invention using functional blocks. In practical implementation, those skilled in the art may use various electronic components or modules to achieve the same function or make different modifications, not limited thereto. For example, in one embodiment, the power supply device 10 can include an enable circuit, such as disposed between the first node N1 and the temperature-controlled current sink circuit 130, used to control the connection between the first node N1 and the temperature-controlled current sink circuit 130 according to an enable signal, thereby controlling the operation of the power supply device 10. In another embodiment, the power supply device 10 may include an over-current protection device, which is electrically connected between the control circuit 120 and the first current source 110 and used to route the current signal I1 to ground according to an over-current signal, thereby preventing damage to downstream circuits from overcurrent. Additionally, the implementation methods of the power switch 100, the first current source 110, the control circuit 120, and the temperature-controlled current sink circuit 130 are not limited to specific components.

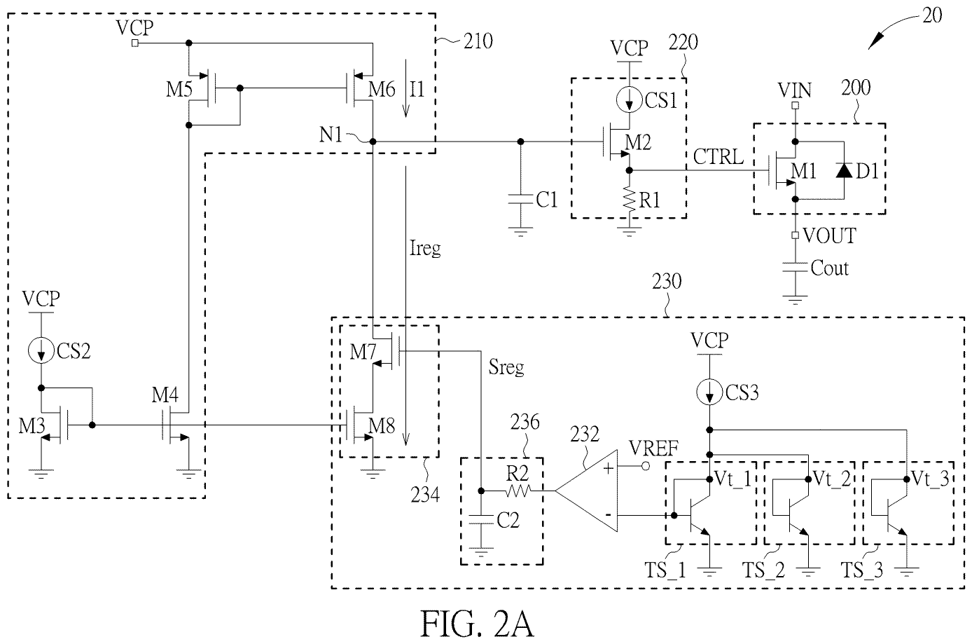

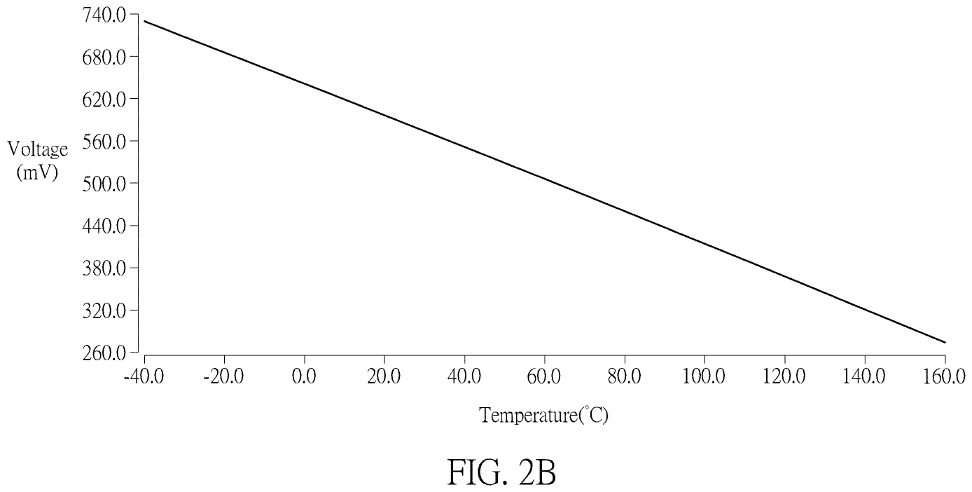

For example, please refer to FIG. 2A, which illustrates a schematic diagram of a power supply device 20 according to an embodiment of the present invention. The power supply device 20 is derived from the power supply device 10 and includes a power switch 200, a first current source 210, a control circuit 220, and a temperature-controlled current sink circuit 230. For conciseness, FIG. 2A reuses some symbols from the power supply device 10 to indicate components or signals with the same function. Specifically, the power switch 200 is implemented with an N-channel enhancement mode Metal-Oxide-Semiconductor Field-Effect Transistor (MOSFET), with its equivalent circuit composed of a MOSFET M1 in parallel with a diode D1. The operating principle thereof is well-known in the field, and it can be replaced with other forms of power switches without limitation. The power switch 200 can convert an input voltage VIN into an output voltage VOUT (i.e., the first power signal P1 and the second power signal P2 in FIG. 1 are in voltage form) and output the output voltage VOUT to an equivalent output capacitor Cout. The first current source 210 consists of a current source CS2 and MOSFETs M3-M6, which form a composite current mirror, and outputs the current signal I1 to the first node N1. In the composite current mirror, the MOSFETs M3 and M4 form an input stage current mirror, while the MOSFETs M5 and M6 form an output stage current mirror. The control circuit 220 includes a current source CS1, a MOSFET M2, and a resistor R1. The drain of MOSFET M2 is electrically connected to the current source CS1, the gate thereof is electrically connected to the first node N1, and the source thereof is electrically connected to resistor R1. Therefore, the MOSFET M2 can receive the current signal I1 from the first node N1 and convert it into the control signal CTRL to drive the power switch 200. Additionally, the gate of the MOSFET M2 gate is connected to ground through a capacitor C1, used to buffer the charging of the MOSFET M2 by the current signal I1, which can be removed or replaced with other buffer components.

In FIG. 2A, the temperature-controlled current sink circuit 230 includes the temperature sensing elements TS_1 to TS_3, an error amplifier 232, a regulation switch 234, and a resistance-capacitance compensator 236. The temperature sensing elements TS_1 to TS_3 are disposed on the power switch 200, capable of sensing the temperature at their disposed locations and generating the corresponding voltage signals Vt_1 to Vt_3. Specifically, the temperature sensing elements TS_1 to TS_3 are respectively implemented with bipolar junction transistors. For the bipolar junction transistor of each of the temperature sensing elements TS_1 to TS_3, its collector and base are electrically connected to the negative terminal (−) of the error amplifier 232 and a current source CS3, while its emitter is electrically connected to ground. Under this configuration, the relationship between the voltage signals Vt_1 to Vt_3 generated by temperature sensing elements TS_1 to TS_3 and the temperature is shown in FIG. 2B, and exhibits approximately a relationship of −2.32 mV/°C., meaning that for every 1° C. temperature rise, the voltage signals Vt_1 to Vt_3 decrease by 2.32 mV. In other words, the temperature sensing elements TS_1 to TS_3 are sensors with negative temperature coefficients, making the generated voltage signals Vt_1 to Vt_3 negatively temperature-related.

Furthermore, the Positive Terminal (+) of the Error amplifier 232 is connected to the reference voltage VREF. Therefore, when temperature rises to cause one or more of the voltage signals Vt_1 to Vt_3 to drop below the reference voltage VREF, the error amplifier 232 will generate a high-level regulation signal Sreg, which can drive the regulation switch 234 to sink (or extract) current from the first node N1 after passing through the resistance-capacitance compensator 236, thereby adjusting the current signal I1 input to the control circuit 220. The resistance-capacitance compensator 236 consists of a resistor R2 and a capacitor C2, electrically connected between the regulation switch 234 and the error amplifier 232, which is used to provide loop stability. The regulation switch 234 is composed of MOSFETs M5 and M6 in a cascode configuration, electrically connected between the first node N1 and ground.

In short, the temperature-controlled current sink circuit 230 can sense the temperature of the power switch 200 and accordingly sink (or extract) the regulation current Ireg from the first node N1 or control the magnitude of the regulation current Ireg, so as to adjust the magnitude of the current signal I1 flowing into the control circuit 220, thereby adjusting the control signal CTRL generated by the control circuit 220. As a result, the output behavior of the power switch 200 is temperature-regulated, which prevents the power switch 200 from overheating while ensuring stable system operation.

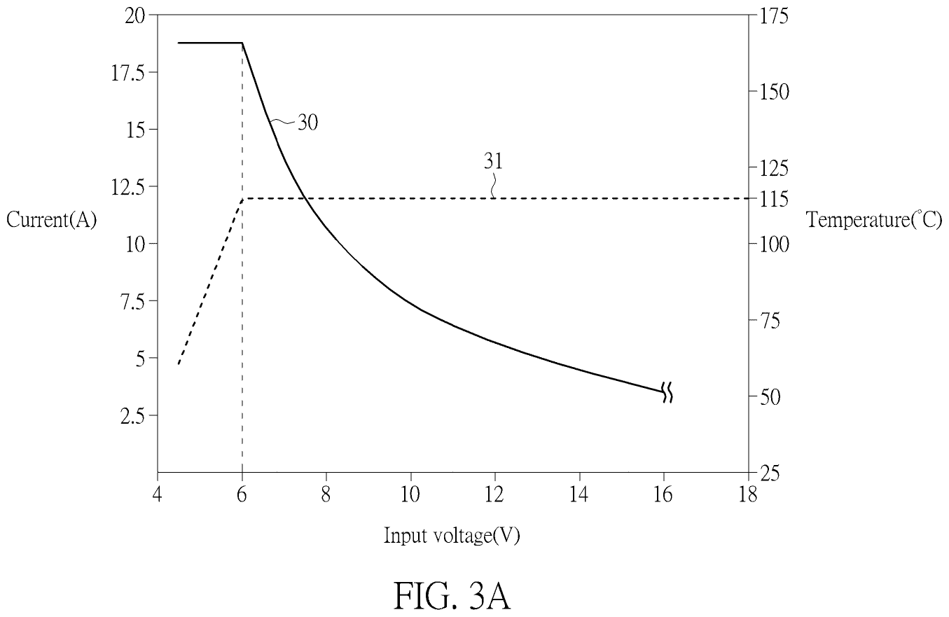

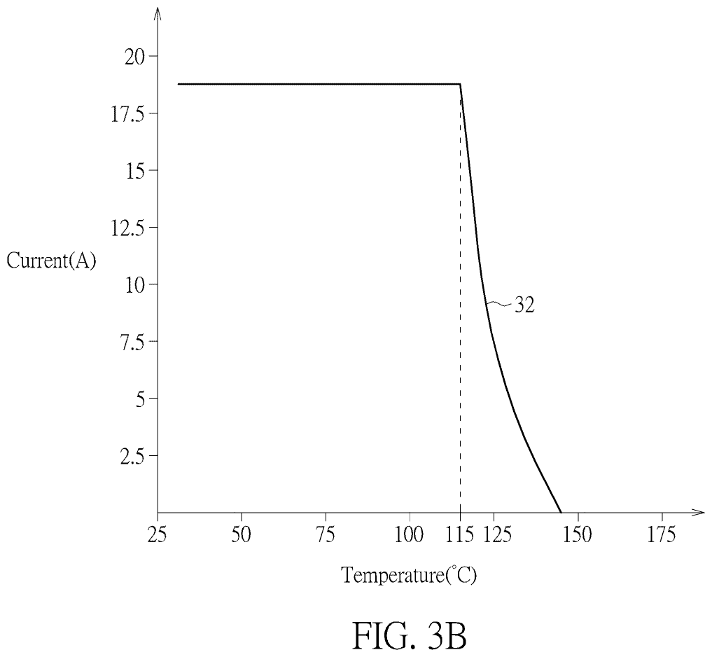

Please continue to refer to FIG. 3A, which illustrates a schematic diagram of temperature regulation of the power supply device 20. In FIG. 3A, the left axis represents current, the bottom axis represents the input voltage VIN, and the right axis represents temperature. The solid curve 30 shows the output current Iout of the power switch 200 (i.e., the current through the capacitor Cout), corresponding to the left and bottom axes. The dashed curve 31 shows the temperature variation of the power switch 200, corresponding to the right axis. In this example, the power supply device 20 initiates temperature regulation for the power switch 200 at 115° C. As can be seen from FIG. 3A, when the power supply device 20 starts up (before the input voltage VIN reaches 6V), the power switch 200 provides the stable output current Iout while the temperature gradually increases. As the input voltage VIN increases beyond 6V, the temperature of the power switch 200 exceeds 115° C., and the power supply device 20 enters the temperature regulation phase. The temperature-controlled current sink circuit 230 begins to sink (or extract) the regulation current Ireg from the first node N1, which causes the output current Iout to decrease, thereby preventing the power switch 200 from overheating and ensuring stable system operation.

It should be noted that FIG. 3A shows one operating scenario among the input voltage VIN, the output current Iout, and the temperature of the power switch 200. In practice, as the temperature-controlled current sink circuit 230 continues to sink current, the temperature of the power switch 200 may drop below the set point of 115° C. At this point, the temperature-controlled current sink circuit 230 can reduce the sunk (or extracted) current or stop sinking current, which allows the output current Iout to return to the initial value. This relationship is illustrated in FIG. 3B, which illustrates the relationship between the output current Iout and the temperature of the power switch 200. As shown by a curve 32 in FIG. 3B, when the temperature of the power switch 200 rises above the set point of 115° C., the temperature-controlled current sink circuit 230 begins sinking current, which reduces the output current Iout. Conversely, when the temperature of the power switch 200 drops from above 115° C. to below 115° C., the temperature-controlled current sink circuit 230 can reduce the sunk (or extracted) current or stop sinking current, which allows the output current Iout to return to the initial value.

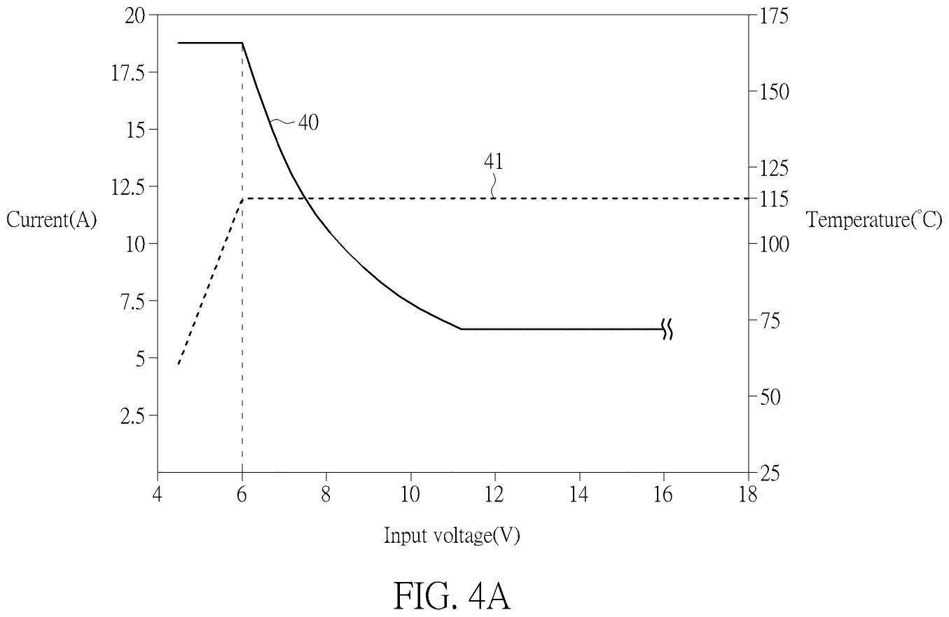

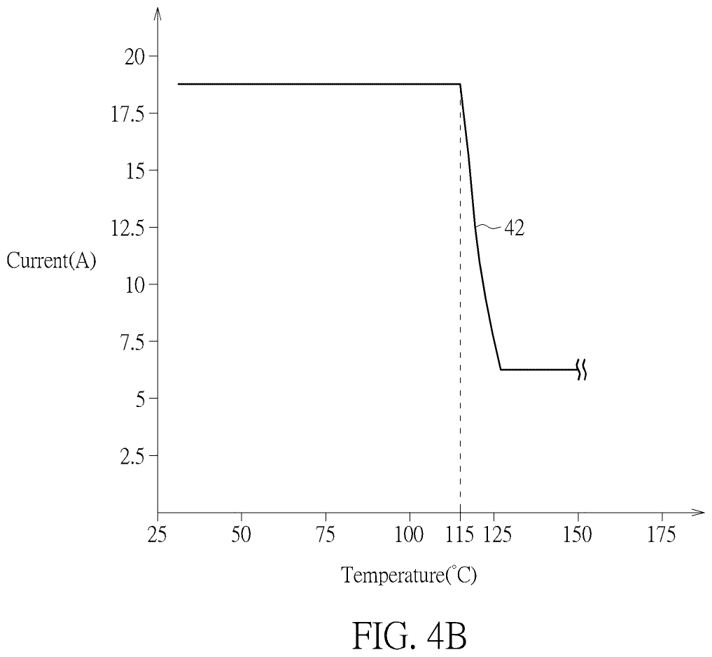

Furthermore, FIG. 3A and FIG. 3B show that when the temperature of the power switch 200 exceeds 115° C., the temperature-controlled current sink circuit 230 continues to sink the regulation current Ireg from the first node N1 until the current signal I1 is completely sunk (equals 0), and at this time, the output current Iout equals 0. However, in another embodiment, designers may appropriately adjust the operation of the regulation switch 234, for example, by changing the dimensions of MOSFETs M5 and M6, to make the maximum value of the regulation current Ireg less than the current signal I1. In this case, the operating results of FIG. 3A and FIG. 3B would become FIG. 4A and FIG. 4B respectively, where the solid curve 40 and the dashed curve 41 in FIG. 4A correspond to the solid curve 30 and the dashed curve 31 in FIG. 3A, and the curve 42 in FIG. 4B corresponds to the curve 32 in FIG. 3B. As can be seen from the curves 40-42 in FIG. 4A and FIG. 4B, when the temperature of the power switch 200 exceeds 115° C., the temperature-controlled current sink circuit 230 continues to sink the regulation current Ireg from the first node N1, which causes the output current Iout to continuously decrease, however, because the maximum value of the regulation current Ireg is less than the current signal I1, the output current Iout will ultimately maintain at a minimum value without further decrease. Compared to the embodiment of FIG. 3A and FIG. 3B, the embodiment of FIG. 4A and FIG. 4B ensures that the system maintains a minimum operating current that can be a design choice. Such modifications to the regulation switch 234 to achieve different operating modes should be familiar to those skilled in the art.

Therefore, the power supply device 20 can actively monitor and control the temperature of the power switch 200 and provides timely regulation when temperature rises too high, which prevents the triggering of thermal shutdown protection mechanisms while maintaining stable system operation. This temperature control method differs from the conventional all-or-nothing protection methods and can more effectively balance system performance and reliability requirements.

The power supply device 20 is derived from the power supply device 10, and those skilled in the art can make appropriate adjustments without limitation. For example, besides appropriately selecting the number and location of temperature sensing elements, designers can also choose other types of temperature sensing elements, not limited to bipolar junction transistors, nor limited to specific temperature coefficients. Moreover, the setting of the reference voltage VREF is related to the timing of beginning to regulate the power switch 200. That is, the error amplifier 232 compares the reference voltage VREF with the voltage signals Vt_1 to Vt_3, and when a rise in the temperature causes the voltage signals Vt_1 to Vt_3 to fall below the reference voltage VREF, the error amplifier 232 will drive the regulation switch 234 to sink current from the first node N1. Therefore, designers should set the value of the reference voltage VREF based on system requirements to determine when the error amplifier 232 drives the regulation switch 234 for regulation, meaning that the setting of the reference voltage VREF is related to the critical or threshold temperature of the power switch 200. As for the implementation methods, components used, and manufacturing processes of the power switch 200, the first current source 210, the control circuit 220, and the temperature-controlled current sink circuit 230, all can be appropriately adjusted based on system requirements without limitation. For example, in one embodiment, except for the temperature sensing elements TS_1 to TS_3 which must be disposed on the power switch 200, the power switch 200, the error amplifier 232, and the regulation switch 234 can be disposed on the same substrate, but not limited to this arrangement. Additionally, in the embodiment of the power supply device 20, the first current source 210, the control circuit 220, and the temperature-controlled current sink circuit 230 are driven by the same system voltage VCP, but in another embodiment, they can be driven by different voltages without limitation.

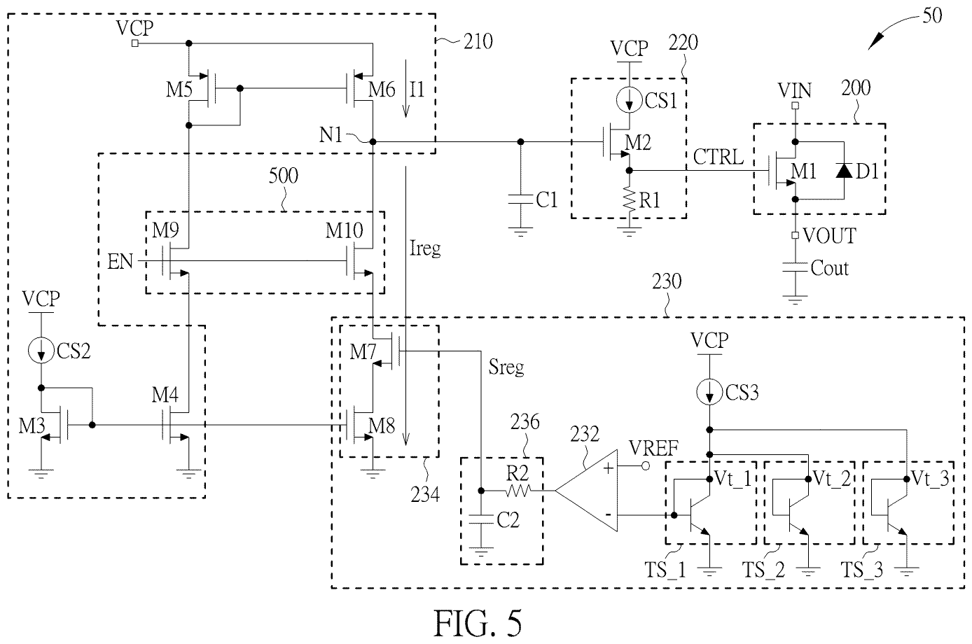

Additionally, the power supply device 20 can incorporate other auxiliary circuits. For example, please refer to FIG. 5, which illustrates a schematic diagram of a power supply device 50 according to an embodiment of the present invention. The power supply device 50 is derived from the power supply device 20, so identical components are marked with the same symbols. Compared to the power supply device 20, the power supply device 50 further includes an enable circuit 500, electrically connected between the first node N1 and the temperature-controlled current sink circuit 230, which can control the connection between the first node N1 and the temperature-controlled current sink circuit 230 according to an enable signal EN. Specifically, the enable circuit 500 consists of MOSFETs M9 and M10, which can control the connections between the MOSFETs M5 and M4 and between MOSFETs M6 and M7 according to the enable signal EN, thereby controlling the operation of the power supply device 50.

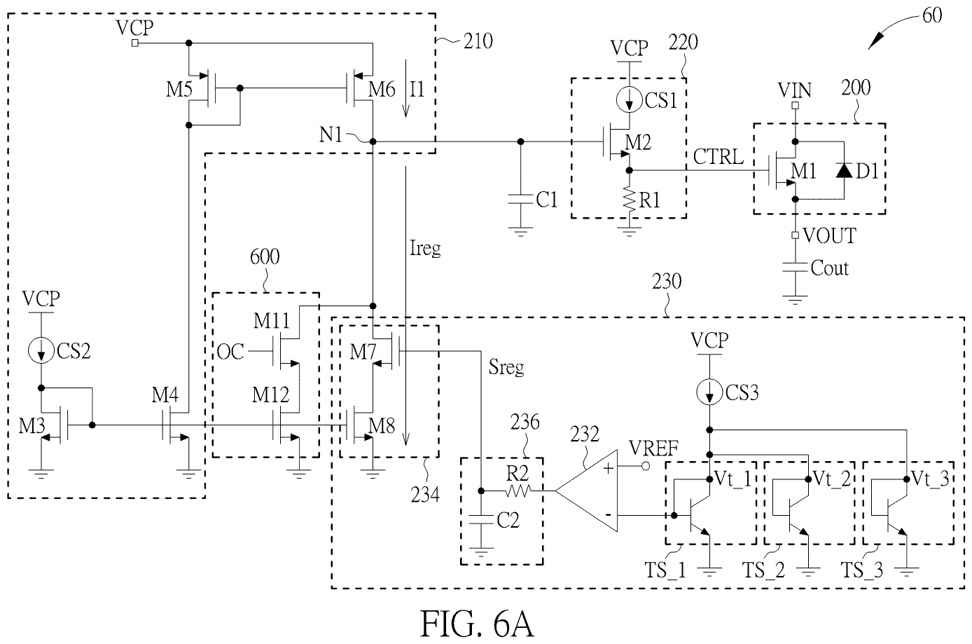

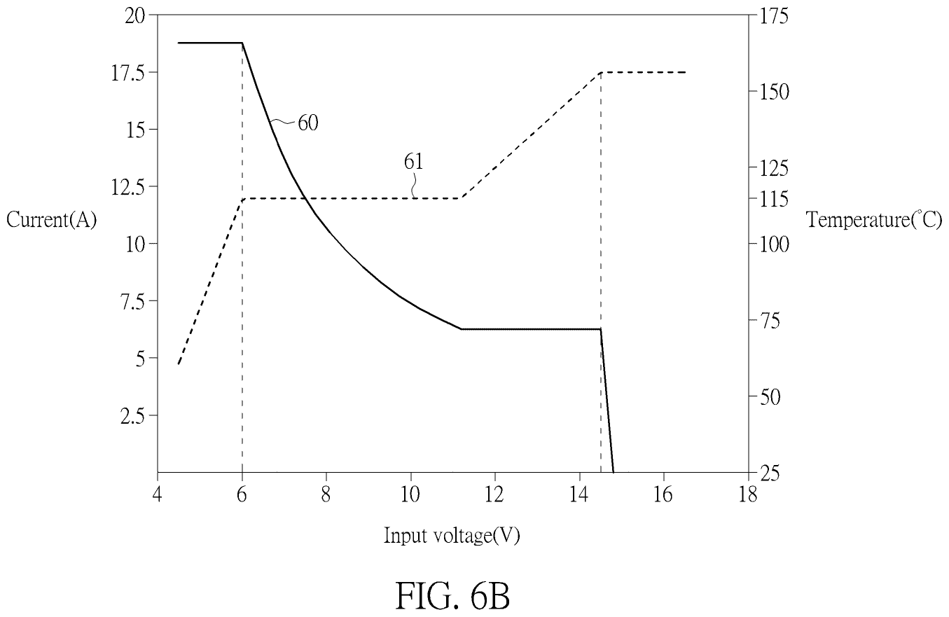

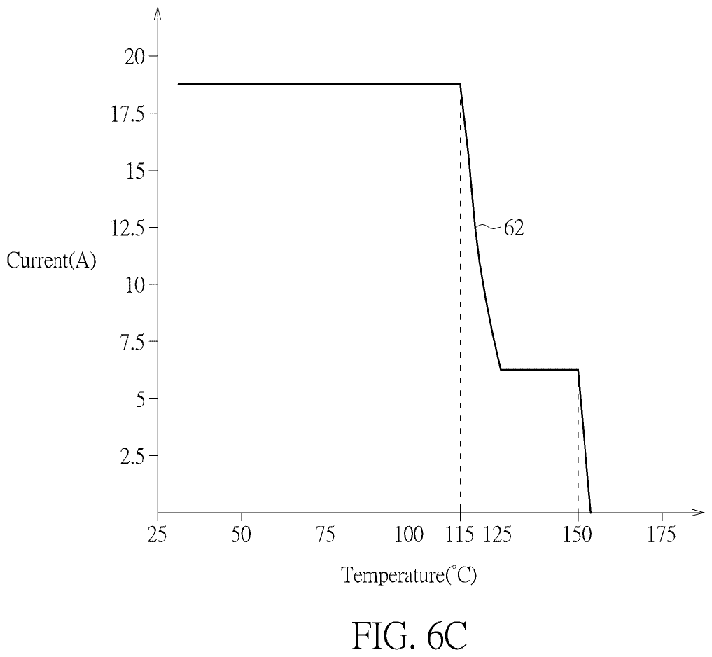

Furthermore, to enhance system stability and reliability, the power supply device 20 may include overcurrent protection functionality, thereby achieving a two-stage protection effect. That is, in addition to the regulation of the output current Iout based on temperature, the system can implement protection when overcurrent conditions occur to prevent components from being damaged. For example, please refer to FIG. 6A, which shows a schematic diagram of a power supply device 60 according to an embodiment of the present invention. The power supply device 60 is derived from the power supply device 20, so identical components are marked with the same symbols. Compared to the power supply device 20, the power supply device 60 further includes an over-current protection device 600 which is electrically connected between the control circuit 220 and the first current source 210 and used to route the current signal I1 to ground according to an over-current signal OC. Specifically, the over-current protection device 600 consists of MOSFETs M11 and M12, which can sink (or extract) current from the first node N1 according to the over-current signal OC. In this case, designers can implement the over-current protection device 600 as a second-stage temperature regulation mechanism. For example, the temperature-controlled current sink circuit 230 can be designed to begin sinking the regulation current Ireg when the temperature of the power switch 200 reaches 115° C., and route the current signal I1 to ground through the over-current protection device 600 when the temperature of the power switch 200 reaches 150° C. As a result, the operating results of the power supply device 60 would transform from FIG. 4A and FIG. 4B to FIG. 6B and FIG. 6C respectively, where the solid curve 60 and the dashed curve 61 in FIG. 6B correspond to the solid curve 40 and the dashed curve 41 in FIG. 4A, and the curve 62 in FIG. 6C corresponds to the curve 62 in FIG. 4B. Referring to the curves 60-62 in FIG. 6B and FIG. 6C, when the temperature of the power switch 200 exceeds 115° C., the temperature-controlled current sink circuit 230 continues to sink the regulation current Ireg from the first node N1, which causes the output current Iout to decrease continuously and maintain at a minimum value. If the temperature of the power switch 200 continues to rise to 150° C., the over-current protection device 600 is activated through the over-current signal OC to route the current signal I1 to ground, which reduces the output current Iout to 0 to protect the system.

It should be noted that FIG. 6B and FIG. 6C explain the operation of the over-current protection device 600 based on FIG. 4A and FIG. 4B. When the over-current protection device 600 is applied to the operating conditions in FIG. 3A and FIG. 3B, similar protection effects would be achieved, as those skilled in the art would understand from the previous explanations. Moreover, the enable circuit 500 of the power supply device 50 and the over-current protection device 600 of the power supply device 60 can be appropriately integrated. For example, in one embodiment, the over-current protection device 600 can be connected between the enable circuit 500 and the temperature-controlled current sink circuit 230; in other words, the drain of MOSFET M11 is electrically connected to the source of the MOSFET M10 and the drain of the MOSFET M7. In another embodiment, the over-current protection device 600 can be connected between the first node N1 and the enable circuit 500, in other words, the drain of the MOSFET M11 is electrically connected to the first node N1 and the drain of the MOSFET M10.

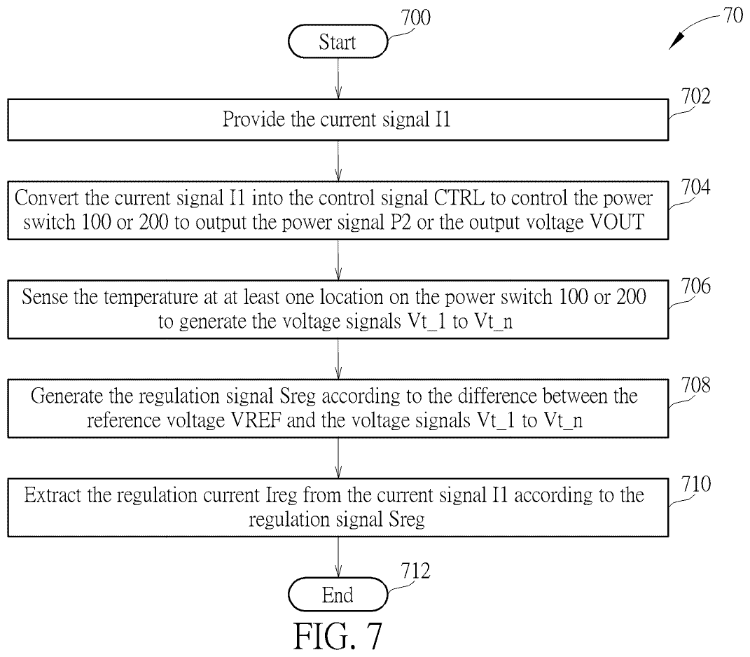

The operating principles of the power supply devices 10, 20, 50, and 60 described above can be summarized into a heat regulation process 70, as shown in FIG. 7. The heat regulation process 70 includes the following steps:
Step 700: Start.
Step 702: Provide the current signal I1.
Step 704: Convert the current signal I1 into the control signal CTRL to control the power switch 100 or 200 to output the power signal P2 or the output voltage VOUT.
Step 706: Sense the temperature at at least one location on the power switch 100 or 200 to generate the voltage signals Vt_1 to Vt_n.
Step 708: Generate the regulation signal Sreg according to the difference between the reference voltage VREF and the voltage signals Vt_1 to Vt_n.
Step 710: Extract the regulation current Ireg from the current signal I1 according to the regulation signal Sreg.
Step 712: End.

For detailed operation of the heat regulation process 70, please refer to the previous explanations.

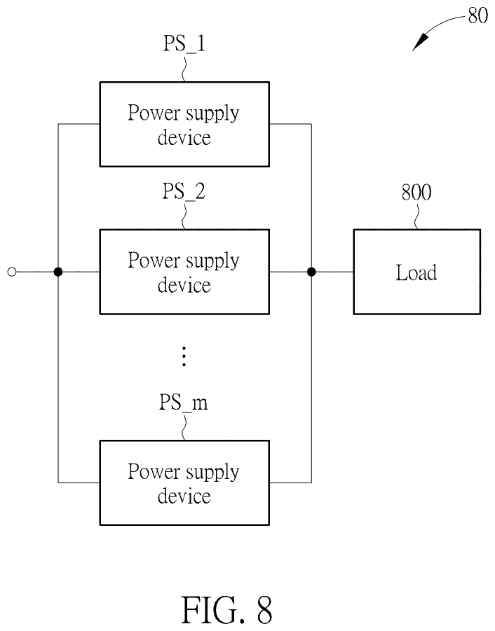

Notably, the preceding embodiments demonstrate how the power supply devices 10, 20, 50, and 60 can actively monitor and control the temperature of the power switch 100 or 200 through the temperature-controlled current sink circuit 130 or 230 and provide timely regulation when temperature rises too high. Therefore, the embodiment of the present invention realizes control and adjustability for a single power supply device. However, this is not limiting, as those skilled in the art can expand the system according to practical requirements during implementation. For example, when multiple outputs are needed, multiple power supply devices can be connected in parallel. For instance, please refer to FIG. 8, which illustrates a schematic diagram of a power supply system 80 according to an embodiment of the present invention. The power supply system 80 includes power supply devices PS_1 to PS_m connected in parallel, where each of the power supply devices PS_1 to PS_m can be one of the power supply devices 10, 20, 50, or 60. More specifically, the power switches within the power supply devices PS_1 to PS_m are connected in parallel. Under this architecture, the power supply system 80 can provide higher current to a load 800 compared to a single power supply device, which enhances driving capability.

Since the power supply devices PS_1 to PS_m are connected in parallel, when one power supply device has a lower on-resistance in its power switch compared to others due to factors such as process variation, current will tend to flow concentratedly through the power switch with lower on-resistance, and potentially subject the power switch to excessive power load. In this case, since the power supply devices of the present invention can actively monitor and control power switch temperature, they can provide timely regulation when temperature rises too high and independently reduce current through overheated power switches, which prevents the triggering of thermal shutdown protection mechanisms. This enhances overall system performance.

In conclusion, the present invention places the temperature sensing elements at critical locations on the power switch of the power supply device, to actively monitor and control the temperature of the power switch, and timely regulate current of the power switch, which prevents the triggering of thermal shutdown protection mechanisms while maintaining stable system operation. Therefore, the present invention not only effectively prevents thermal shutdown issues caused by localized hot spots or transient high currents but also ensures power switch reliability while maintaining normal system operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power supply device, comprising:
a power switch, configured to convert a first power signal into a second power signal according to a control signal;
a first current source, configured to provide a current signal to a first node;
a control circuit, electrically connected to the power switch and further to the first current source at the first node, configured to convert the current signal into the control signal; and
a temperature-controlled current sink circuit, comprising:
at least one temperature sensing element, disposed at at least one location on the power switch, configured to generate at least one voltage signal, wherein the at least one voltage signal is respectively related to a temperature of the at least one location;
an error amplifier, electrically connected to the at least one temperature sensing element for receiving the at least one voltage signal, configured to generate a regulation signal according to the at least one voltage signal and a reference voltage; and
a regulation switch, electrically connected to the first node and the error amplifier, configured to sink a regulation current from the current signal at the first node according to the regulation signal.

2. The power supply device of claim 1, wherein each of the at least one temperature sensing element is a bipolar junction transistor, with a collector and a base electrically connected to the error amplifier and a second current source, and an emitter electrically connected to a ground.

3. The power supply device of claim 2, wherein the at least one voltage signal is negatively temperature-related.

4. The power supply device of claim 1, further comprising an over-current protection device, electrically connected between the control circuit and the first current source, configured to route the current signal to a ground according to an over-current signal.

5. The power supply device of claim 1, wherein the temperature-controlled current sink circuit further comprises:
a resistance-capacitance compensator, electrically connected between the regulation switch and the error amplifier, for providing loop stability.

6. The power supply device of claim 1, wherein the power switch, the regulation switch, and the error amplifier are disposed on a same substrate.

7. The power supply device of claim 1, wherein the control circuit comprises:
a current source;
a resistor; and
a metal-oxide-semiconductor field-effect transistor, having a drain electrically connected to the current source, a gate electrically connected to the first node, and a source electrically connected to the resistor.

8. The power supply device of claim 1, further comprising an enable circuit, electrically connected between the first node and the temperature-controlled current sink circuit, configured to conducting a connection between the first node and the temperature-controlled current sink circuit according to an enable signal.

9. The power supply device of claim 1, wherein the at least one temperature sensing element is a sensor with a negative temperature coefficient.

10. The power supply device of claim 1, further comprising a capacitor, electrically connected between the first node and a ground.

11. A heat regulation method, utilized in a power supply device comprising a power switch and a control circuit, the heat regulation method comprising:
providing a current signal;
converting the current signal into a control signal, to control the power switch to output a power signal;
sensing a temperature at at least one location on the power switch, to generate at least one voltage signal;
generating a regulation signal according to a difference between a reference voltage and the at least one voltage signal; and
extracting a regulation current from the current signal according to the regulation signal.

12. The heat regulation method of claim 11, wherein the at least one voltage signal is negatively temperature-related.

13. The heat regulation method of claim 11, further comprising routing the current signal to a ground according to an over-current signal.

14. A power supply system, comprising a plurality of power supply devices, and each of the power supply devices comprising:
a power switch, configured to convert a first power signal into a second power signal according to a control signal;
a first current source, configured to provide a current signal to a first node;
a control circuit, electrically connected to the power switch and further to the first current source at the first node, configured to convert the current signal into the control signal; and
a temperature-controlled current sink circuit, comprising:
at least one temperature sensing element, disposed at at least one location on the power switch, configured to generate at least one voltage signal, wherein the at least one voltage signal is respectively related to a temperature of the at least one location;
an error amplifier, electrically connected to the at least one temperature sensing element for receiving the at least one voltage signal, configured to generate a regulation signal according to the at least one voltage signal and a reference voltage; and
a regulation switch, electrically connected to the first node and the error amplifier, configured to sink a regulation current from the current signal at the first node according to the regulation signal;
wherein the power switches of the plurality of power supply devices are connected in parallel.

15. The power supply system of claim 14, wherein each of the at least one temperature sensing element is a bipolar junction transistor, with a collector and a base electrically connected to the error amplifier and a second current source, and an emitter electrically connected to a ground.

16. The power supply system of claim 15, wherein the at least one voltage signal is negatively temperature-related.

17. The power supply system of claim 14, wherein each power supply device further comprises an over-current protection device, electrically connected between the control circuit and the first current source, configured to route the current signal to a ground according to an over-current signal.

18. The power supply system of claim 14, wherein the temperature-controlled current sink circuit of each power supply device further comprises:
a resistance-capacitance compensator, electrically connected between the regulation switch and the error amplifier, for providing loop stability.

19. The power supply system of claim 14, wherein the control circuit of each power supply device comprises:
a current source;
a resistor; and
a metal-oxide-semiconductor field-effect transistor, having a drain electrically connected to the current source, a gate electrically connected to the first node, and a source electrically connected to the resistor.

20. The power supply system of claim 14, wherein the at least one temperature sensing element is a sensor with a negative temperature coefficient.
